(19) United States
(12) Patent Application Publication
(10) Pub. No.: US 2018/0332621 A1
(43) Pub. Date: Nov. 15, 2018

(54) RANDOM ACCESS RESOURCES IN A TELECOMMUNICATION NETWORK

(71) Applicant: Telefonaktiebolaget LM Ericsson (publ), Stockholm (SE)

(72) Inventors: Erik Eriksson, Linköping (SE); Martin Hessler, Linköping (SE); Pål Frenger, Linköping (SE); Gunnar Bark, Linköping (SE)

(21) Appl. No.: 15/543,493

(22) PCT Filed: Feb. 27, 2015
(86) PCT No.: PCT/SE2015/050219

§ 371 Date: Jul. 13, 2017

(51) Int. Cl. H04W 74/08

(52) U.S. Cl. CPC H04W 74/0833

(57) ABSTRACT

According to an aspect, there is provided a method of operating a network node in a telecommunication network to provide an additional random access, RA, resource to a periodic RA resource provided by a first signal from the telecommunication network, the method comprising selectively transmitting a second signal to one or more terminal devices in the telecommunication network to provide an additional RA resource, the second signal indicating information required for a RA request on the additional RA resource by the one or more terminal devices.

### TECHNICAL FIELD

The present disclosure relates to providing random access, RA, resources to terminal devices in a telecommunication network.

### BACKGROUND

Work is ongoing in designing a baseline for the next generation telecommunication networks. To reduce energy consumption in the network and to fully enable the utilization of high gain beam forming or other multi-antenna techniques a concept has been defined in which the control/broadcast layer is separated from the data plane. The broadcast layer consists of broadcasted system information and a broadcasted sync/discovery signal structure, where the sync signal may be used to map information from the broadcasted system information. The broadcasted signals should be able to be sent in a single frequency network (SFN) structure. Broadcasted system information can contains parameter settings indicating how terminal devices can access the network, perform random access, and be reached (paged) by the network.

Random access, RA, is a process by which a terminal device (e.g. a user equipment, UE) can access a telecommunication network, for example to initiate a call or a data session. The terminal device sends an RA request in a random access channel (RACH) that is shared with other terminal devices that wish to access the network. If two terminal devices transmit their RA requests at the same time, a collision may occur and the RA request will fail.

The broadcasted system information provides terminal devices with information required for making a RA request to the network, such as the timing of RA requests, the frequency or frequencies at which RA requests should be transmitted and/or the transmission power that should be used to transmit the RA request. In some networks, the information required for making a RA request to the network is broadcast periodically with a fixed period, with a time slot for RA requests being set a defined time after the broadcast of the information. This is illustrated in FIG. 1 which shows the periodic broadcast of a synchronization and detection signal (SSS) with a period Tₛₛₛ by the network and a RA resource (physical random access channel, PRACH) on the uplink (UL) a defined time Δtₛₛₛ after the broadcast of the SSS in which terminal devices can send a RA request to the network.

To reduce the energy consumption of next generation networks, the random access sync signal (e.g. SSS) is expected to be broadcast less frequently than the corresponding reference signals broadcast in current cellular networks.

However, since random access by a terminal device has a time and/or frequency relation to the downlink (DL) synchronization signal, the random access can only occur close in time to the DL synchronization signal. Broadcasting these signals less frequently means that the capacity and latency of the random access procedure will be limited. This could be a particular problem for certain UEs, coverage areas, etc.

### SUMMARY

The techniques described in the present disclosure address problems with infrequent broadcast of the signals that provide information required for the transmission of RA requests by terminal devices and allow for the selective scaling of random access capacity in a network or specific area to provide a balance between network energy performance and random access capacity and latency.

According to a first embodiment, there is provided a method of operating a network node in a telecommunication network to provide an additional random access, RA, resource to a periodic RA resource provided by a first signal from the telecommunication network, the method comprising selectively transmitting a second signal to one or more terminal devices in the telecommunication network to provide an additional RA resource, the second signal indicating information required for a RA request on the additional RA resource by the one or more terminal devices.

In some embodiments the information indicated in the second signal comprises information on timing and/or frequency alignment of the RA request and/or transmission power to be used by the terminal devices.

In some embodiments the step of selectively transmitting the second signal comprises transmitting the second signal when additional RA resource is required. The step of selectively transmitting the second signal comprises transmitting the second signal in response to information received from another network node. The information received from another network node may relate to the movement of one or more terminal devices in the telecommunication network.

In some embodiments the step of selectively transmitting the second signal comprises transmitting the second signal when a signal metric for the periodic RA resource meets a predetermined criteria. The signal metric may be a load of the periodic RA resource, and the second signal may be transmitted when the load is above a threshold. Alternatively, the signal metric may be an indication of the level of uplink interference in the periodic RA resource, and the second signal may be transmitted when the level of uplink interference is above a threshold.

In some embodiments the method further comprises the step of transmitting an indication to the one or more terminal devices that the second signal is to be transmitted.

In some embodiments the method further comprises the step of transmitting a mapping between the second signal and one or more terminal devices that are permitted to use the additional RA resource to the one or more terminal devices.

In some embodiments the step of selectively transmitting the second signal comprises transmitting the second signal over an area that is the same size or smaller than the area covered by the first signal, or that is overlapping with the area covered by the first signal.

In some embodiments the method further comprises the step of periodically transmitting the first signal to provide the periodic RA resource, the first signal indicating information required for a RA request by the one or more terminal devices on the periodic RA resource. The information indicated in the first signal may comprise information on timing and/or frequency alignment of the RA request and/or transmission power to be used by the terminal devices. The first signal may indicate timing information for the transmission of the second signal. In some embodiments the timing information for the transmission of the second signal indicates one or more time offsets from the transmission of the first signal that the second signal is to be transmitted.

In some embodiments the method further comprises the step of transmitting a mapping between the first signal and one or more instances of the second signal to the one or more terminal devices.

According to a second aspect, there is provided a network node for use in a telecommunication network to provide an additional random access, RA, resource to a periodic RA resource provided by a first signal from the telecommunication network, the network node being adapted to selectively transmit a second signal to one or more terminal devices in the telecommunication network to provide an additional RA resource, the second signal indicating information required for a RA request on the additional RA resource by the one or more terminal devices.

In some embodiments the information indicated in the second signal comprises information on timing and/or frequency alignment of the RA request and/or transmission power to be used by the terminal devices.

In some embodiments the network node is adapted to selectively transmit the second signal when additional RA resource is required. The network node may be adapted to selectively transmit the second signal in response to information received from another network node. The information received from another network node may relate to the movement of one or more terminal devices in the telecommunication network.

In some embodiments the network node is adapted to selectively transmit the second signal when a signal metric for the periodic RA resource meets a predetermined criteria. The signal metric may be a load of the periodic RA resource, and the network node may be adapted to transmit the second signal when the load is above a threshold. Alternatively, the signal metric may be an indication of the level of uplink interference in the periodic RA resource, and the network node may be adapted to selectively transmit the second signal when the level of uplink interference is above a threshold.

In some embodiments the network node is further adapted to transmit an indication to the one or more terminal devices that the second signal is to be transmitted.

In some embodiments the network node is further adapted to transmit a mapping between the second signal and one or more terminal devices that are permitted to use the additional RA resource to the one or more terminal devices.

In some embodiments the network node is adapted to selectively transmit the second signal over an area that is the same size or smaller than the area covered by the first signal, or that is overlapping with the area covered by the first signal.

In some embodiments the network node is further adapted to periodically transmit the first signal to provide the periodic RA resource, the first signal indicating information required for a RA request by the one or more terminal devices on the periodic RA resource. The information indicated in the first signal may comprise information on timing and/or frequency alignment of the RA request and/or transmission power to be used by the terminal devices. The first signal may indicate timing information for the transmission of the second signal. In some embodiments the timing information for the transmission of the second signal indicates one or more time offsets from the transmission of the first signal that the second signal is to be transmitted.

In some embodiments the network node is further adapted to transmit a mapping between the first signal and one or more instances of the second signal to the one or more terminal devices.

According to a third aspect, there is provided a method of operating a terminal device in a telecommunication network, the method comprising receiving a first signal from a network node in the telecommunication network that indicates information required for a random access, RA, request by the terminal device on a periodic RA resource; and receiving a second signal from a network node that indicates information required for a RA request by the terminal device on an additional RA resource to the periodic RA request.

In some embodiments the information required for a RA request on the periodic RA resource indicated in the first signal comprises information on timing and/or frequency alignment of the RA request and/or transmission power to be used by the terminal device.

In some embodiments the information required for a RA request on the additional RA resource indicated in the second signal comprises information on timing and/or frequency alignment of the RA request and/or transmission power to be used by the terminal device.

In some embodiments the first signal further indicates timing information for the transmission of the second signal. In some embodiments the timing information indicates one or more time offsets from the transmission of the first signal that the second signal is to be transmitted.

In some embodiments the method further comprises the step of receiving an indication from a network node that the second signal is to be transmitted.

In some embodiments the method further comprises the step of receiving a mapping between the second signal and one or more terminal devices that are permitted to use the additional RA resource. In some embodiments the method further comprises the step of determining whether to transmit a RA request on the periodic RA resource or the additional RA resource based on the received mapping.

In some embodiments the method further comprises the step of receiving a mapping between the first signal and one or more instances of the second signal.

In some embodiments the step of receiving a second signal from a network node comprises receiving multiple second signals, each second signal indicating respective information required for a RA request on an additional RA resource by the terminal device; and wherein the method further comprises the step of selecting a second signal from the multiple second signals. In some embodiments the step of selecting a second signal from the multiple second signals comprises selecting the second signal in the multiple second signals that has the highest signal strength at the terminal device. In alternative embodiments the step of selecting a second signal from the multiple second signals comprises selecting the second signal in the multiple second signals that was received first. In other alternative embodiments the step of selecting a second signal from the multiple second signals comprises selecting the second signal in the multiple second signals according to a second signal priority list. In some embodiments the multiple second signals are received from different network nodes.

In some embodiments the first signal is received from a first network node and the second signal is received from a second network node. In other embodiments the first signal and second signal are received from the same network node.

In some embodiments the method further comprises the steps of determining whether to transmit a RA request on the periodic RA resource or the additional RA resource; and transmitting the RA request to the network node on the determined one of the periodic RA resource or the additional RA resource.

In some embodiments the method further comprises the step of transmitting a further RA request to the network node in the event that the RA request is unsuccessful. In some embodiments the further RA request is transmitted with a higher transmission power than the unsuccessful RA request. In some embodiments the amount by which the transmission power for the further RA request is higher depends on the number of unsuccessful RA requests or further RA requests transmitted to the network node. In alternative embodiments the amount by which the transmission power for the further RA request is higher depends on whether the periodic RA resource or the additional RA resource is used for the transmission of the further RA request.

In some embodiments, in the event that a RA request transmitted on the additional RA resource is unsuccessful, the method further comprises the step of transmitting further RA requests to the network node until a RA request is successful or a maximum number of RA requests are transmitted on the additional RA resource. In some embodiments, in the event that a maximum number of RA requests are transmitted on the additional RA resource, the method further comprises the step of transmitting a RA request on the periodic RA resource.

In some embodiments, in the event that a RA request transmitted on the periodic RA resource is unsuccessful, the method further comprises the step of transmitting further

RA requests to the network node until a RA request is successful or a maximum number of RA requests are transmitted on the periodic RA resource. In some embodiments, in the event that a maximum number of RA requests are transmitted on the periodic RA resource, the method further comprises the step of sending a RA request on the additional RA resource.

According to a fourth aspect, there is provided a terminal device for use in a telecommunication network, the terminal device being adapted to receive a first signal from a network node in the telecommunication network that indicates information required for a random access, RA, request on a periodic RA resource by the terminal device; and receive a second signal from a network node that indicates information required for a RA request on an additional RA resource to the periodic RA resource by the terminal device.

In some embodiments the information required for a RA request on the periodic RA resource indicated in the first signal comprises information on timing and/or frequency alignment of the RA request and/or transmission power to be used by the terminal device.

In some embodiments the information required for a RA request on the additional RA resource indicated in the second signal comprises information on timing and/or frequency alignment of the RA request and/or transmission power to be used by the terminal device.

In some embodiments the first signal further indicates timing information for the transmission of the second signal. In some embodiments the timing information indicates one or more time offsets from the transmission of the first signal that the second signal is to be transmitted.

In some embodiments the terminal device is further adapted to receive an indication from a network node that the second signal is to be transmitted.

In some embodiments the terminal device is further adapted to receive a mapping between the second signal and one or more terminal devices that are permitted to use the additional RA resource. In some embodiments the terminal device is further adapted to determine whether to transmit a RA request on the periodic RA resource or the additional RA resource based on the received mapping.

In some embodiments the terminal device is further adapted to receive a mapping between the first signal and one or more instances of the second signal.

In some embodiments the terminal device is adapted to receive multiple second signals, each second signal indicating respective information required for a RA request on an additional RA resource by the terminal device; and wherein the terminal device is further adapted to select a second signal from the multiple second signals. In some embodiments the terminal device is adapted to select a second signal from the multiple second signals that has the highest signal strength at the terminal device. In alternative embodiments the terminal device is adapted to select the second signal in the multiple second signals that was received first. In other alternative embodiments the terminal device is adapted to select the second signal in the multiple second signals according to a second signal priority list. In some embodiments the multiple second signals are received from different network nodes.

In some embodiments the first signal is received from a first network node and the second signal is received from a second network node. In other embodiments the first signal and second signal are received from the same network node.

In some embodiments the terminal device is further adapted to determine whether to transmit a RA request on the periodic RA resource or the additional RA resource; and to transmit the RA request to the network node on the determined one of the periodic RA resource or the additional RA resource.

In some embodiments the terminal device is further adapted to transmit a further RA request to the network node in the event that the RA request is unsuccessful. In some embodiments the terminal device is adapted to transmit the further RA request with a higher transmission power than the unsuccessful RA request. In some embodiments the amount by which the transmission power for the further RA request is higher depends on the number of unsuccessful RA requests or further RA requests transmitted to the network node. In alternative embodiments the amount by which the transmission power for the further RA request is higher depends on whether the periodic RA resource or the additional RA resource is used for the transmission of the further RA request.

In some embodiments, in the event that a RA request transmitted on the additional RA resource is unsuccessful, the terminal device is further adapted to transmit further RA requests to the network node until a RA request is successful or a maximum number of RA requests are transmitted on the additional RA resource. In some embodiments, in the event that a maximum number of RA requests are transmitted on the additional RA resource, the terminal device is further adapted to transmit a RA request on the periodic RA resource.

In some embodiments, in the event that a RA request transmitted on the periodic RA resource is unsuccessful, the terminal device is further adapted to transmit further RA requests to the network node until a RA request is successful or a maximum number of RA requests are transmitted on the periodic RA resource. In some embodiments, in the event that a maximum number of RA requests are transmitted on the periodic RA resource, the terminal device is further adapted to send a RA request on the additional RA resource.

According to a fifth aspect, there is provided a computer program product comprising a computer readable medium having computer readable code embodied therein, the computer readable code being configured such that, on execution by a suitable computer or processing unit, the computer or processing unit is caused to perform any of method embodiments described above.

### BRIEF DESCRIPTION OF THE DRAWINGS

Exemplary embodiments of the techniques introduced in this document are described below with reference to the following figures, in which:

FIG. 1 is a diagram illustrating the timing of the periodic broadcast of a synchronization and detection signal in the downlink and a random access channel available in the uplink;

FIG. 2 is a non-limiting example block diagram of an LTE cellular communications network;

FIG. 3 is a block diagram of a terminal device according to an embodiment;

FIG. 4 is a block diagram of a radio access network node according to an embodiment;

FIG. 5 is a block diagram of a core network node according to an embodiment;

FIG. 6 is a diagram illustrating the timing of the periodic transmission of a synchronization and detection signal in the downlink, a random access channel available in the uplink, an additional synchronization signal in the downlink and additional random access resource in the uplink according to an embodiment;

FIG. 7 is a signaling diagram illustrating the transmission of signals by a network node and the transmission of random access requests by terminal devices;

FIG. 8 is a flow chart illustrating the operation of a network node according to an embodiment;

FIG. 9 is a flow chart illustrating the operation of a terminal device according to an embodiment;

FIG. 10 is a diagram illustrating the provision of additional random access resources to specific areas; and

FIG. 11 is a diagram illustrating the provision of additional random access resources to specific terminal devices.

### DETAILED DESCRIPTION

The following sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions or computer readable code that would cause a processor (and also in some cases a receiver component and/or transmitter component) to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing units, one or more processing modules or one or more controllers, and the terms computer, processor, processing unit, processing module and controller may be employed interchangeably. When provided by a computer, processor, processing unit, processing module or controller, the functions may be provided by a single dedicated computer, processor, processing unit, processing module or controller, by a single shared computer, processor, processing unit, processing module or controller, or by a plurality of individual computers, processors, processing units, processing modules or controllers, some of which may be shared or distributed. Moreover, the terms “processor”, “processing unit”, “processing module” or “controller” also refer to other hardware capable of performing such functions and/or executing software, such as the example hardware recited above.

Although the description is given for a terminal device or user equipment (UE), it should be understood by the skilled in the art that “terminal device” and “UE” are non-limiting terms comprising any mobile, non-mobile or wireless device or node equipped with a radio interface allowing for at least one of: transmitting signals in uplink (UL) and receiving and/or measuring signals in downlink (DL). A UE herein may comprise a UE (in its general sense) capable of operating or at least performing measurements in one or more frequencies, carrier frequencies, component carriers or frequency bands. It may be a “UE” operating in single- or multi-radio access technology (RAT) or multi-standard mode. It will be appreciated that a “mobile device” does not necessarily have to be mobile in the sense that it is carried by a user. Instead, the term “mobile device”, as with “terminal device” encompasses any device that is capable of communicating with communication networks that operate according to one or more mobile communication standards, such as GSM, UMTS, LTE, etc or future ‘5G’ communication standards.

A cell is associated with a radio access network (RAN) node, where a RAN node comprises in a general sense any node transmitting radio signals in the downlink (DL) to a terminal device and/or receiving radio signals in the uplink (UL) from a terminal device. Some example RAN nodes, or terms used for describing RAN nodes, are base station, eNodeB, eNB, NodeB, macro/micro/pico/femto radio base station, home eNodeB (also known as femto base station), relay, repeater, sensor, transmitting-only radio nodes or receiving-only radio nodes. A RAN node may operate or at least perform measurements in one or more frequencies, carrier frequencies or frequency bands and may be capable of carrier aggregation. It may also be a single-radio access technology (RAT), multi-RAT, or multi-standard node, e.g., using the same or different base band circuitry for different RATs.

It should be noted that unless otherwise indicated, the use of the general term “network node” as used herein refers to a RAN node, such as a base station, an eNodeB, a network node in the RAN responsible for resource management, such as a radio network controller (RNC), a core network node, such as a mobility management entity (MME) or a serving gateway (SGW).

The signaling described is either via direct links or logical links (e.g. via higher layer protocols and/or via one or more network nodes). For example, signaling from a coordinating node may pass another network node, e.g., a radio node.

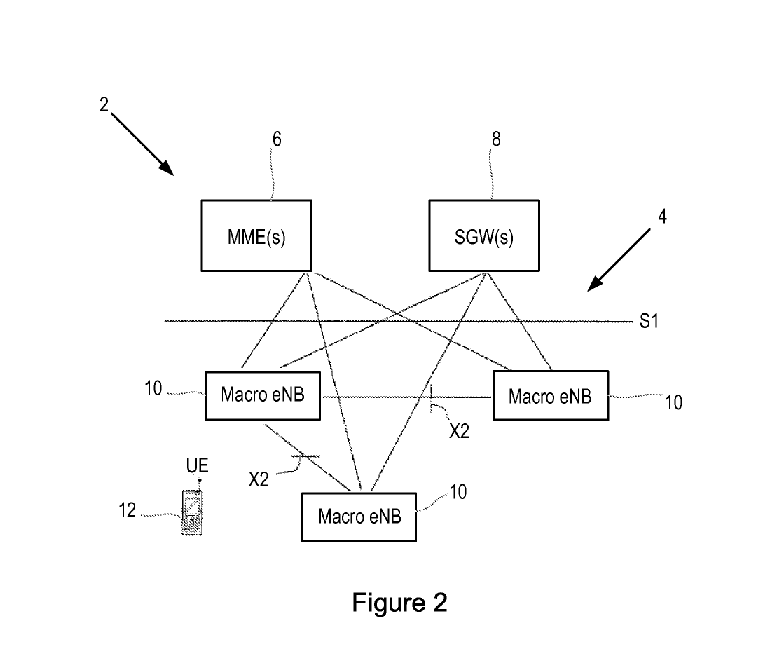

FIG. 2 shows an example diagram of an evolved UMTS Terrestrial Radio Access Network (EUTRAN) architecture as part of an LTE-based telecommunication network 2 in which various embodiments can be implemented. It will be appreciated however that the various embodiments can also be implemented in other types of network, including future ‘5G’ telecommunication networks. Nodes in the core network 4 include one or more Mobility Management Entities (MMEs) 6, a key control node for the LTE access network, and one or more Serving Gateways (SGWs) 8 which route and forward user data packets while acting as a mobility anchor. They communicate with base stations 10 in the RAN referred to in LTE as eNBs or eNodeBs, over an interface, for example an S1 interface. The eNBs 10 can include the same or different categories of eNBs, e.g. macro eNBs, and/or micro/pico/femto eNBs. The eNBs 10 communicate with each other over an interface, for example an X2 interface. The S1 interface and X2 interface are defined in the LTE standard. A UE 12 can receive downlink data from and send uplink data to one of the base stations 10 with that base station 10 being referred to as the serving base station of the UE 12.

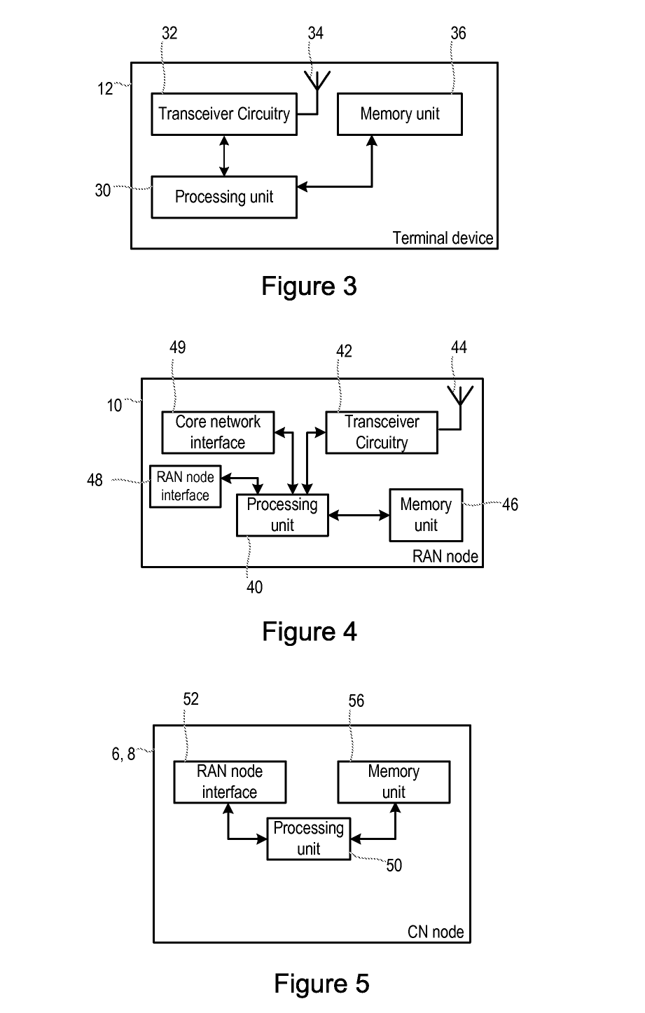

FIG. 3 shows a terminal device 12 or user equipment (UE) that can be adapted for use in one or more of the non-limiting example embodiments described. The terminal device 12 comprises a processing unit 30 that controls the operation of the terminal device 12. The processing unit 30 is connected to a receiver or a transceiver 32 (which comprises a receiver and a transmitter) with associated antenna(s) 34 which are used to receive signals from or both transmit signals to and receive signals from a radio access network, such as RAN node 10 in the LTE network 2. The terminal device 12 also comprises a memory unit 36 that is connected to the processing unit 30 and that stores computer program code and other information and data required for the operation of the terminal device 12.

FIG. 4 shows a RAN node 10 (for example a base station, NodeB or an eNodeB) that can be adapted for use in example embodiments described. The RAN node 10 comprises a processing unit 40 that controls the operation of the base station 10. The processing unit 40 is connected to a transmitter or a transceiver 42 (which comprises a receiver and a transmitter) with associated antenna(s) 44 which are used to transmit signals to, and receive signals from, terminal devices 12 in the network 2. The RAN node 10 also comprises a memory unit 46 that is connected to the processing unit 40 and that stores computer program code and other information and data required for the operation of the RAN node 10. In this embodiment the RAN node 10 also includes components and/or circuitry 48 for allowing the RAN node 10 to exchange information with other RAN nodes 10 (for example via an X2 interface) and components and/or circuitry 49 for allowing the RAN node 10 to exchange information with nodes in the core network 4 (for example via the S1 interface). It will be appreciated that RAN nodes for use in other types of network (e.g. UTRAN or WCDMA RAN) may include similar components to those shown in FIG. 4 and may, if appropriate, include interface circuitry 48, 49 for enabling communications with the other network nodes in those types of networks (e.g. other base stations, mobility management nodes and/or nodes in the core network).

FIG. 5 shows a core network node 6, 8 that can be adapted for use in the example embodiments described. The node 6, 8 comprises a processing unit 50 that controls the operation of the node 6, 8. The processing unit 50 is connected to components and/or circuitry 52 for allowing the node 6, 8 to exchange information with RAN nodes 10 with which it is associated (which is typically via the S1 interface). The node 6, 8 also comprises a memory unit 56 that is connected to the processing unit 50 and that stores computer program code and other information and data required for the operation of the node 6, 8.

It will be appreciated that only the components of the terminal device 12, RAN node 10 and core network node 6, 8 that are useful to explain the embodiments presented herein are illustrated in FIGS. 3, 4 and 5.

The techniques described herein address problems with the infrequent (or less frequent) broadcast of the signals that provide information required for the transmission of random access, RA, requests by terminal devices 12 and allow for the selective scaling of random access capacity in a network 2 or specific area to provide a balance between network energy performance and random access capacity and latency.

In particular, according to the techniques described herein, the network 2 continues to transmit the existing periodic signal that provides terminal devices 12 with information required for making RA request to the network 2, and also selectively transmits another signal that provides terminal devices 12 with additional RA resources for transmitting RA requests to the network 2.

The existing periodic signal (of which the SSS is an example) is referred to herein as a “first signal”, and the signal that is selectively transmitted by the network 2 to provide additional RA resources is referred to herein as a “second signal”. As described in more detail below, the first signal is a periodic signal that is transmitted by one or more nodes 10 in the network 2 and that provides a periodic RA resource to terminal devices 12 wishing to access the network 2, and the second signal is another signal (that, when transmitted, may be periodic and may have the same or a different period to the first signal) that is selectively transmitted at certain times by one or more nodes 10 in the network 2 to provide further RA resources to the RA resource provided by the periodic first signal. As used herein, an RA resource is a potentially contention-based channel or time and/or frequency slot where multiple terminal devices 12 can transmit RA requests without an explicit grant from the network 2 for that time instance. The RA resource may be an access channel with or without payload data.

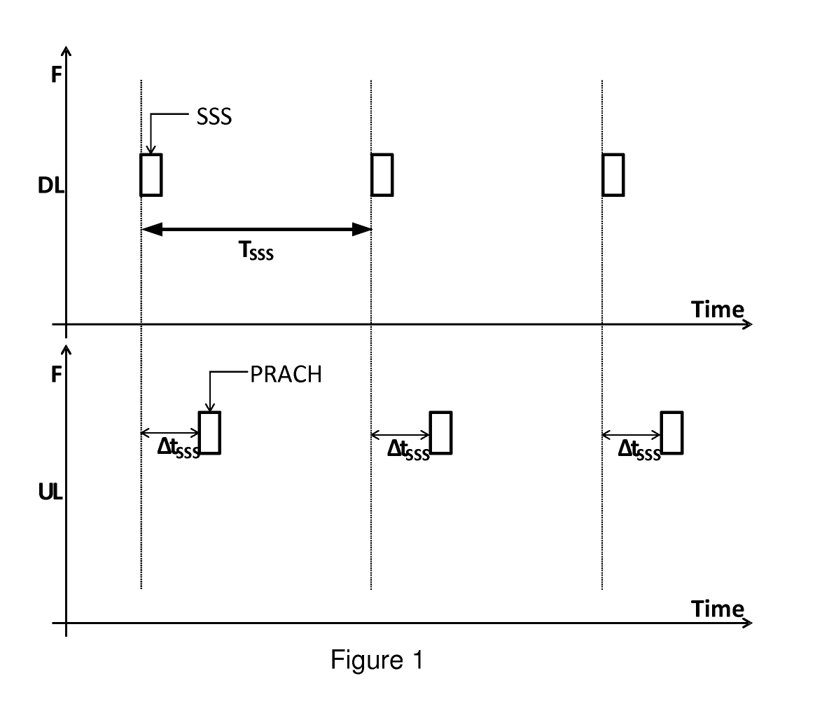

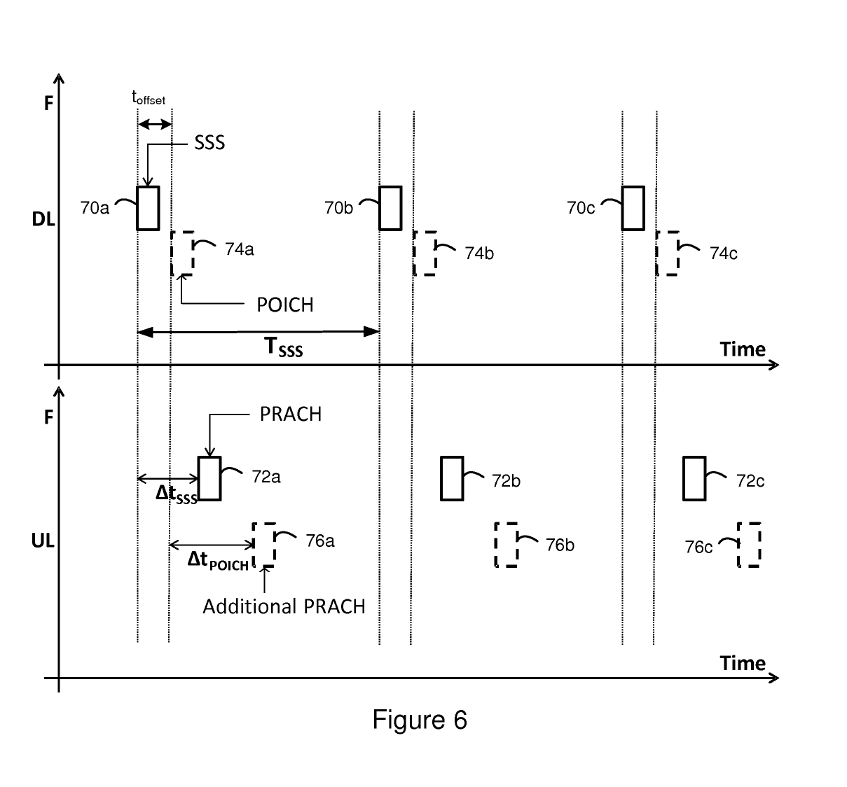

An example of the second signal and the additional RA resource provided thereby is shown in FIG. 6. Similar to FIG. 1, FIG. 6 shows the periodic transmission of a synchronization and detection signal (SSS) 70 with a fixed period Tₛₛₛ by the network 2. Each transmission of the SSS 70 provides terminal devices 12 with the information required to transmit a RA request to the network 2 in a RA resource (denoted the physical random access channel, PRACH). In particular, each transmission of the SSS (individually denoted 70a, 70b, 70c) provides a corresponding RA resource (denoted 72a, 72b, 72c respectively) that starts a defined time Δtₛₛₛ after the transmission of the SSS 70. In addition to providing the information on the timing of the RA resource (which, as noted, is provided by the transmission/reception of the SSS 70 itself), the SSS 70 can provide information on the frequency or frequencies that the terminal devices 12 are to transmit the RA request on and/or the transmission power that should be used. The periodic SSS 70 can be said to provide a default PRACH period.

As noted above, when additional RA resources are required, the second signal is transmitted by the network 2 to the terminal devices 12 (i.e. the second signal is selectively transmitted). In this disclosure the second signal has also been given the exemplary name of a PRACH Opportunity Indicator Channel (POICH). The second signal 74 (POICH) is transmitted, as shown in FIG. 6 by transmissions 74a, 74b and 74c, and provides terminal devices 12 with the information required to transmit a RA request to the network 2 in an additional RA resource (labelled the additional PRACH in FIG. 6). In particular embodiments, each transmission of the POICH (74a, 74b, 74c) provides a corresponding additional RA resource (denoted 76a, 76b, 76c respectively) that starts a defined time Δt_{POICH} after the transmission of the POICH. In alternative embodiments, each transmission of the POICH (74a, 74b, 74c) provides multiple corresponding additional RA resources. The number of additional RA resources provided by each transmission of the POICH 74 could be fixed or configured by the network node 10.

In some embodiments, in addition to providing the information on the timing of the additional RA resource, the POICH 74 can provide information on the frequency or frequencies that the terminal devices 12 are to transmit the RA request on and/or the transmission power that should be used. In alternative embodiments, the information on the frequency or frequencies and/or transmission power that should be used can be provided by an alternative means, for example the SSS 70 (particularly where the frequency and/or transmission power is the same as that used for the periodic RA resource 72).

In FIG. 6, the SSS 70 and POICH 74 are shown as being transmitted on different frequencies to each other. However, it will be appreciated that in some embodiments the SSS 70 and POICH 74 could be transmitted on the same frequency. Likewise, the additional PRACH 76 is shown in FIG. 6 as having a different frequency to the PRACH 72. In some embodiments the additional PRACH 76 may have the same frequency as the PRACH 72.

Also in FIG. 6, the SSS 70 and POICH 74 are shown as being transmitted periodically (i.e. when active, the POICH 74 is transmitted every Tₛₛₛ). However, it will be appreciated that in some embodiments the POICH 74 could be transmitted with a different (higher or lower) period to the SSS 70 to provide a desired amount of additional RA resource. For example, with the SSS 70 and the POICH 74 having the same period as in FIG. 6, transmitting the POICH 74 doubles the RA resource available to terminal devices 12 compared to only transmitting the SSS 70. Transmitting the POICH 74 with a period of Tₛₛₛ/2 (i.e. twice as often as the SSS 70) would triple the RA resource available to terminal devices 12 compared to only transmitting the SSS 70. As an alternative to transmitting the POICH 74 with a different period to the SSS 70, the same effect of tripling the available RA resources can be obtained by transmitting two POICH 74 with respective offsets from the SSS 70 that each have the same period as the SSS 70 and that provide a respective set of additional RA resources (that can be on the same or different frequencies to each other). In further embodiments, more than two different POICH can be transmitted to further increase the available RA resources.

It will be noted from FIG. 6 that the POICH 74 is transmitted some time after the SSS 70 (this time is referred to herein as an ‘offset’ from the SSS 70, particularly when the POICH 74 has the same period as the SSS 70, and is denoted by t_{offset} in FIG. 6). The size of this offset can be preset or varied as required by the network 2. For example (and unlike in FIG. 6), in some embodiments the offset could be set so that each transmission of the POICH 74a, 74b, 74c falls generally midway between consecutive transmissions of the SSS 70a, 70b, 70c in order to evenly spread the RA resource 72, 76 over time. In some embodiments, the offset is preconfigured in the network 2, so that terminal devices 12 will be aware of the relative timing of the POICH 74 to the SSS 70.

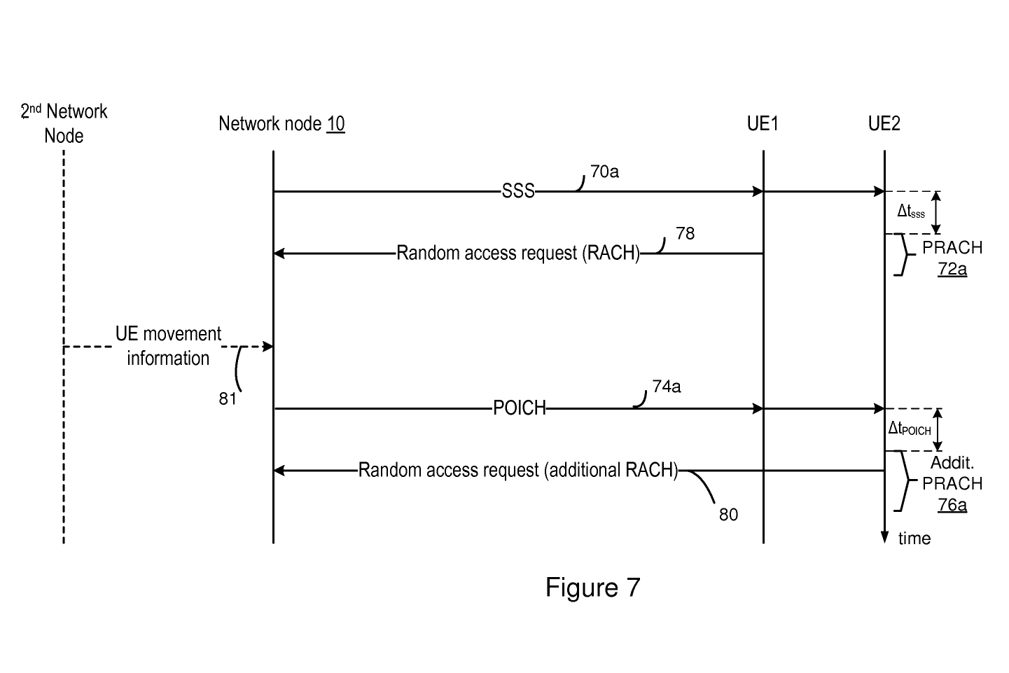

FIG. 7 is an exemplary signaling diagram illustrating the transmission of signals 70a and 74a from FIG. 6 by a network node and the transmission of random access requests by terminal devices. FIG. 7 shows a network node 10 (for example an eNodeB) that periodically transmits an SSS and selectively transmits a periodic POICH for terminal devices 12 in the cell of the node 10. In this example two terminal devices 12, denoted UE1 and UE2, are within the coverage of the network node 10 and receive the SSS 70a. As noted above the SSS 70a provides the information required for terminal devices 12 to transmit RA requests to the network (in this case to network node 10). During PRACH 72a UE1 transmits an RA request 78 to the network node 10. At this time UE2 does not need to access the network 2 and therefore no RA request is transmitted.

Subsequently the network node 10a transmits the POICH 74a which provides the additional RA resource (PRACH 76a) and this is received by both UE1 and UE2. UE2 wishes to access the network 2 and therefore UE2 transmits an RA request 80 to the network node 10 during PRACH 76a. Without the additional PRACH provided by the POICH, UE2 would need to wait until the next transmission of the SSS (SSS 70b) before being able to send the RA request. Thus the transmission of the POICH reduces the latency of the RA procedure for UE2.

As described in more detail below, although a single network node 10 is shown in FIG. 7 as transmitting both the SSS 70 and the POICH 74 to the terminal devices 12 in its cell, in some embodiments it is possible for the SSS 70 and POICH 74 to be transmitted by different network nodes (for example by different antennas on a base station, or by separate nodes within a cell).

In some embodiments (which can be in addition to or alternative to the embodiment in which the SSS 70 and POICH 74 are transmitted by different nodes 10) it is possible for the SSS 70 and POICH 74 to have different coverage areas. Thus in some embodiments the SSS 70 could be transmitted over the whole cell, and the POICH 74 could be transmitted to a selected part or parts of the cell, for example to a part of the cell in which there are a large number of terminal devices 12 and collisions are more likely to occur between their RA requests.

In some embodiments (which can be in addition to or alternative to the above embodiments), the additional RA resource provided by the POICH 74 can be ‘reserved’ for use by certain terminal devices 12, for example higher priority terminal devices 12 or users.

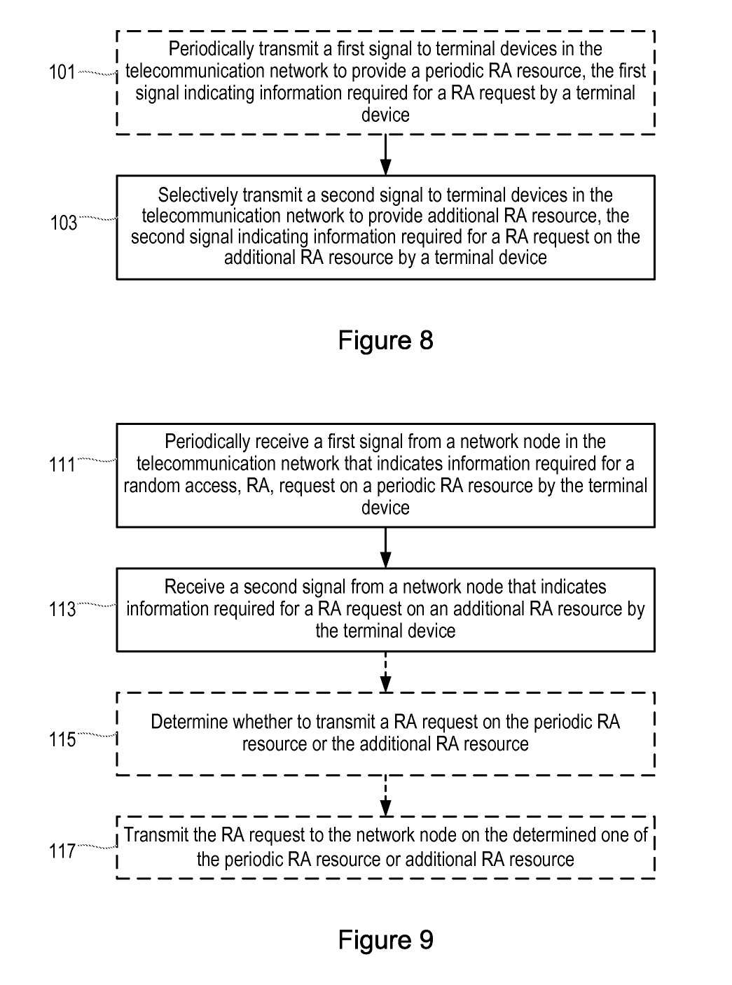

A method of operating a network node 10 in a telecommunication network 2 according to an embodiment is shown in FIG. 8. In a first step, step 101, (which is optional since different nodes may transmit the SSS 70 and POICH 74), the node 10 periodically transmits a first signal (e.g. the SSS 70) to provide a periodic RA resource (PRACH 72) for terminal devices 12 that would like to access the network 2. The first signal indicates information required for a RA request by a terminal device 12 on the periodic RA resource 72. As noted above, the information required for a RA request on the periodic RA resource 72 can comprise information on timing and/or frequency alignment of the RA request and/or the transmission power to be used by terminal devices 12.

In a second step, step 103, the network node 10 selectively transmits a second signal (e.g. POICH 74) to terminal devices 12 in the telecommunication network 2 to provide an additional RA resource 76 to the periodic RA resource 74. The second signal indicates information required for a RA request on the additional RA resource by a terminal device 12. As noted above, the information required for a RA request on an additional RA resource indicated in the second signal can comprise information on the timing and/or frequency alignment of the RA request and/or transmission power to be used by terminal devices 12.

As noted above, the second signal 74 is selectively transmitted, for example when an additional RA resource is required. Selectively transmitting can therefore comprise determining if additional RA resource is required, and if so, transmitting the second signal. If an additional RA resource is not required, the network node may not transmit the second signal 74.

In some embodiments, the second signal 74 is transmitted in response to a signal metric for the periodic RA resource meeting a predetermined criteria. For example, the signal metric can be the load on the periodic RA resource 72, and the network node 10 can start transmitting the second signal when the load for the periodic RA resource is above a threshold. The load can be measured as the interference/energy detected in the time frequency resource used for RA) and/or the number of detected RAs within a given time-window, i.e. the usage of the channel compared to its maximal capacity. Similar criteria can be applied to determine if the network node 10 should stop transmitting the second signal 74, although it will be appreciated that it may be useful to take into account the combined load on the periodic RA resource 72 and the additional RA resource 76 to ensure that stopping transmission of the second signal 74 does not immediately lead to a large number of UEs 12 trying to use the periodic RA resource 72.

In alternative embodiments the signal metric is an indication of the level of uplink interference in the periodic RA resource (i.e. an indication of the amount of collisions between different RA requests/RA preambles), and the network node 10 can start transmitting the second signal when the level of uplink interference is above a threshold. Similar criteria can be applied to determine if the network node 10 should stop transmitting the second signal 74.

In some embodiments a network node 10 can decide to start transmitting the second signal 74 in response to information received from another network node 10. For example the information received from another network node 10 can relate to the movement of one or more terminal devices 12 in the telecommunication network, and particularly between cells, or between different parts of a cell (in the case where the second signal 74 can be transmitted over a certain part of a cell).

For example a RAN node 10 or core network node 6, 8 may indicate to the network node 10 that a large number of terminal devices 12 are approaching the cell, e.g. in a train traveling towards the cell. This is indicated in FIG. 7 by signal 81 sent from a second network node to the network node 10. The second network node may be a radio base station currently handling/serving the terminal devices 12 or may be a separate network function with, for example, location-tracking of public transportation. In response to this UE movement information from the other network node, the network node 10 can start to transmit the POICH 74 to handle the likely peak in RA requests.

A method of operating a terminal device 12 in a telecommunication network 2 according to an embodiment is shown in FIG. 9. In a first step, step 111, the terminal device 12 periodically receives a first signal (e.g. SSS 70) from a network node 10 in the telecommunication network 2. The first signal indicates information required for a RA request on a periodic RA resource (PRACH 72) by the terminal device 12.

In a second step, step 113, the terminal device 12 receives a second signal (e.g. POICH 74) from a network node 10 in the network 2. The second signal indicates information required for an RA request on an additional RA resource by the terminal device 12. It will be appreciated that the second signal 74 may be received from a different network node 10 to the network node 10 that the first signal 70 is received from. The second signal 74 can be received on the same or a different frequency to the first signal 70.

In step 115, which is optional, the terminal device 12 determines whether to transmit a RA request on the periodic RA resource 72 or the additional RA resource 76. In some embodiments, when the terminal device 12 determines that an RA request is to be sent, step 115 can comprise the terminal device 12 determining that the next available RA resource, i.e. on the PRACH 72 or additional PRACH 76, whichever occurs first, should be used for the RA request. Various alternative implementations of step 115 are described in more detail below.

In step 117, which is also optional, the terminal device 12 transmits an RA request 78/80 to the network node 10 on the determined one of the periodic RA resource 74 or additional RA resource 76.

Thus the techniques described herein provide for the configuration, transmission and usage of a second signal, denoted a PRACH occasion indication channel (POICH) 74 to indicate the presence of additional RA resources 76 on top of an existing periodic RA resource configuration 72. Based on receiving a POICH transmission 74 in step 113, a UE 12 can derive some or all of the transmission-related parameters for a preamble transmission on a PRACH 72/76. As noted above, the transmission-related parameter can be the timing, frequency alignment and/or output (transmission) power.

Although not described in any further detail herein, it will be appreciated by those skilled in the art that the POICH 74 has a structure to enable time frequency synchronization and detection of the presence of the POICH 74 by terminal devices 12.

In some embodiments the setting of the transmission power to use for an initial RA request transmission on an additional PRACH resource 76 in step 117 is calculated according to the information in the POICH signal 74, and the POICH 74 can provide different information (and thus a different initial transmission power) to the information used for power setting on the periodic PRACH resource 72 provided in the SSS 70. In alternative embodiments, the information on the transmission power to use for an RA request on the additional RA resource 76 can be derived from the information received in the SSS 70. In other alternative embodiments, the setting of the transmission power on an additional PRACH resource 76 is derived using a different power setting formula (or set of parameters) to that used for deriving the transmission power on the periodic PRACH resource 72.

In some embodiments, the terminal device 12 can apply power ramping (i.e. increasing the transmission power) for subsequent transmissions of RA requests in the event that an initial or previous RA request has failed. In some embodiments, the amount or rate by which the transmission power is increased depends on the number of unsuccessful RA requests. In some embodiments, the amount or rate by which the transmission power is increased depends on whether the failed RA request was transmitted on the periodic RA resource 72 or an additional RA resource 76 provided by a POICH 74. In the event that there are multiple POICH 74 in a cell, the power ramping can be the same or different for each POICH 74. Thus the power step to use can be dependent on the number of PRACH attempts made by the UE 12 on the additional RA resource scheduled by one or a group of POICH 74.

In some embodiments, in the event that an initial RA request using the additional RA resource has failed, the UE 12 may make a further number of attempts up to a maximum permitted number of attempts. The maximum number of attempts can be determined per POICH 74 or set of POICH 74. For example only a limited number of RA request attempts may be permitted using an RA resource 76 associated with a POICH 74 before the UE 12 is required to send the RA request in the periodic RA resource 72 provided by the SSS 70.

In alternative embodiments, the opposite situation is applied. Thus, in the event that an initial RA request using the periodic RA resource 72 fails, the UE 12 may make a further number of attempts up to a maximum permitted number of attempts. Once the maximum number of attempts is reached, the UE 12 may be required to send the RA request using the additional RA resource provided by the POICH 74.

In some embodiments, terminal devices 12 can be configured to listen for (i.e. attempt to receive in step 113) the POICH 74 in one or more time windows that are defined in relation to each received SSS signal 70a, 70b, 70c. These time windows correspond to the offset referred to above and shown as t -offset in FIG. 6. Thus, in some embodiments, the parameters (e.g. timing) for a terminal device 12 to receive the second signal 74 from the network node 10 are directly derived from the first signal 70. In some embodiments, the information in the SSS 70 can directly indicate the timing of the POICH 74 in relation to the SSS 70 (e.g. the information in the SSS 70 can indicate the offset, t_{offset}).

In embodiments where more than one instance of a POICH 74 is transmitted in a cell or area (with the multiple POICH being transmitted by the same or different network nodes 10), each of the multiple different POICH signals 74 can be configured or derivable from the first signal 70. In some embodiments the SSS 70 can indicate the timing (t_{offset}) of each of the multiple POICH 74 from the SSS 70. In other embodiments there is a fixed, standardized mapping between the first signal 70 and each of the multiple POICH 74. This mapping can indicate the timing, frequency and/or transmission power relationship between the first signal 70 and each of the different POICH 74. Where the mapping is standardized, it can be preconfigured in the terminal devices 12. Alternatively, whether the mapping is standardized or dynamic, the mapping can be signaled to UEs 12 by the network node 10 using broadcast or dedicated signaling.

If a UE 12 detects multiple (different) POICH 74 in step 113 (and which therefore provide respective additional RA resources 76), a selection rule can be applied in step 115 to determine which of the POICH 74 should be used by the UE 12 when an RA request is to be transmitted. In some embodiments the selection rule can make use of a priority list to select a POICH 74. In other embodiments, the UE 12 can select the RA resource 76 associated with the strongest received POICH 74 (i.e. highest signal strength). This embodiment will lead to the UE 12 selecting the strongest downlink transmitter of POICH 74. In other embodiments, the UE 12 can select the RA resource 76 associated with the first received POICH 74, i.e. the POICH signal that is the earliest in time to arrive at the UE 12. Where the multiple POICH are transmitted at the same time, this embodiment will result in the UE 12 selecting the closest, and likely to be best, uplink node 10. In some embodiments the UE 12 can be configured to weight the received power difference and/or timing difference as part of the selection rule. In some embodiments the weighting is POICH dependent.

In some embodiments, since the POICH 74 is only selectively transmitted (i.e. not transmitted all the time), the UE 12 may be informed, by broadcast or dedicated signaling from the network node 10, that a POICH may be present (i.e. transmitted by the network node 10).

As mentioned above, in some embodiments it is possible for the coverage area of a second signal (POICH 74) to be different from the coverage area of the first signal (SSS 70). The coverage area of the second signal 74 for a particular cell may be larger, smaller or partially overlapping with the coverage area of the first signal 70 for the cell.

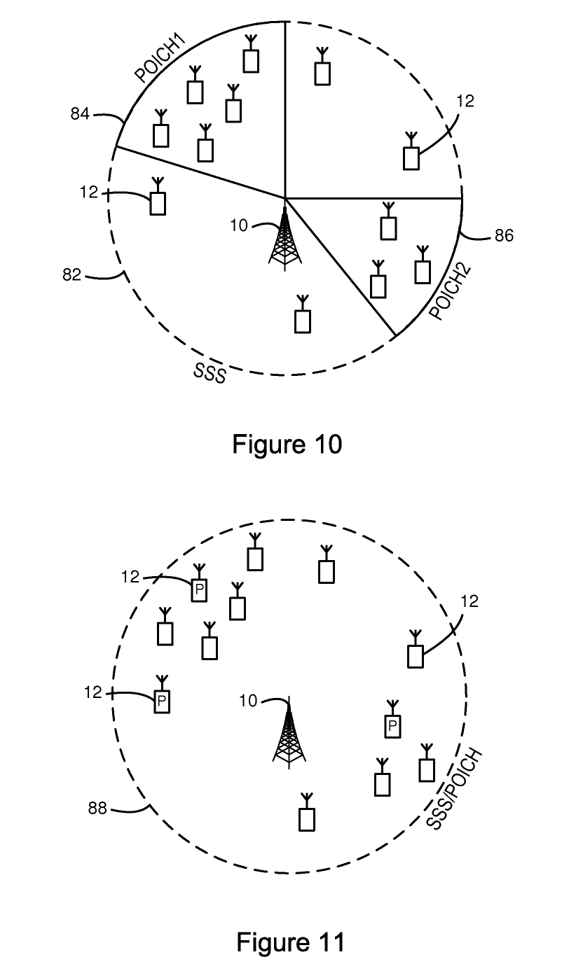

An example of the spatial variation in SSS 70 and POICH 74 is illustrated in FIG. 10. The SSS 70 provides a periodic RA resource over the entire cell, as indicated by dashed circle 82. However it may be the case that certain parts of the cell may experience higher loads/have a tendency to have a larger number of UEs 12 that need to access the network 2 than other parts. Such parts could correspond to locations where there are buildings, roads, etc, and these parts may not always be adequately served by the SSS 70. Thus, in this case, when required, the network node 10 can transmit a POICH 74 to a specific part of the cell, which is indicated by sector 84 in FIG. 10) to provide additional RA resource to the UEs 12 in that sector. FIG. 10 also shows a second sector 86 in which a POICH 74 is transmitted for use by the UEs 12 in that area. FIG. 10 shows the POICH 74 in these sectors 82, 84 as POICH1 and POICH2 respectively, and it will be appreciated that POICH1 and POICH2 can be different POICH 74 (i.e. with different timing and/or frequency and/or transmission power parameters to each other) or they can be the same POICH transmitted in selected directions.

It will be appreciated by those skilled in the art that area-specific activation of a POICH 74 can be achieved by transmitting the POICH signal by adjusting the antenna weights compared to the first signal 70, using a transmission point that is separate from the main network node 10 in the cell, by transmitting the first signal 70 jointly from multiple transmission points and only sending the POICH(s) 74 from a subset of transmission points, or by transmitting the POICH 74 from transmission points that are not transmitting the first synchronization signal.

In some embodiments it is possible for access control (i.e. the availability of RA resources) to be different for different types of UEs 12 within a cell. For example a UE 12 that has a lower priority (for example due to a subscription level or quality of service, QoS, requirement) or capability (e.g. is not capable of receiving a POICH) may not be permitted to make use of any additional RA resource provided by a POICH 74, or, in the event that multiple POICH are used, the UE 12 may only be permitted to make use of a subset of the additional RA resources. By contrast, a high priority or high capability UE 12 may be permitted to make use of any additional RA resource provided in the cell. An example of this access control is illustrated in FIG. 11. In this Figure, the SSS 70 and one or more POICH 74 are transmitted over the cell (indicated by dashed circle 88). Certain UEs 12 marked with a ‘P’ in FIG. 11 are deemed to be higher priority UEs 12 and are permitted to make use of the additional RA resource provided by the POICH 74. The other UEs 12 not marked with a ‘P’ are normal or lower priority UEs 12 and can only make use of the periodic RA resource provided by the SSS 70.

In some embodiments UEs 12 may be preconfigured with information indicating whether they can make use of one or more POICH 74. In alternative embodiments, the network 2 may determine a mapping of POICH(s) 74 to priority level/specific UEs 12, and provide this mapping to the UEs 12 via broadcast or dedicated signaling. In alternative embodiments, implicit mapping can be used by the network 2 configuring high priority UEs 12 with some of the potential POICH 74, while configuring all UEs 12 with the other POICH. This feature enables fast switching in access control without updating system information broadcast.

It will be appreciated that some implementations of the techniques described herein can make use of both the spatial variation in SSS and POICH embodiment and the access control embodiment described above.

The amount of additional PRACH opportunities/resources may be listed in System Information. When only SSS is transmitted PRACH is allowed every 100 ms but with an additional POICH PRACH is allowed every 5 ms even though the POICH may still be transmitted only every 100 ms.

Thus, the techniques described herein provide for the introduction of a new signal (POICH) for selectively providing additional RA resources, with low latency, and with the ability to limit the additional RA resources to a smaller area than the system broadcast area and/or to a subset of terminal devices 12 in the network 2.

Modifications and other variants of the described embodiment(s) will come to mind to one skilled in the art having the benefit of the teachings presented in the foregoing descriptions and the associated drawings. Therefore, it is to be understood that the embodiment(s) is/are not to be limited to the specific examples disclosed and that modifications and other variants are intended to be included within the scope of this disclosure. Although specific terms may be employed herein, they are used in a generic and descriptive sense only and not for purposes of limitation.

1. A method of operating a network node in a telecommunication network to provide an additional random access, RA, resource to a periodic RA resource provided by a first signal from the telecommunication network, the method comprising:
selectively transmitting a second signal to one or more terminal devices in the telecommunication network to provide an additional RA resource, the second signal indicating information required for a RA request on the additional RA resource by the one or more terminal devices.

2. The method as claimed in claim 1, wherein the information indicated in the second signal comprises information on timing and/or frequency alignment of the RA request and/or transmission power to be used by the terminal devices.

3. The method as claimed in claim 1, wherein the step of selectively transmitting the second signal comprises transmitting the second signal when additional RA resource is required.

4. The method as claimed in claim 1, wherein the step of selectively transmitting the second signal comprises transmitting the second signal in response to information received from another network node.

5. The method as claimed in claim 4, wherein the information received from another network node relates to the movement of one or more terminal devices in the telecommunication network.

6-17. (canceled)

18. A network node for use in a telecommunication network to provide an additional random access, RA, resource to a periodic RA resource provided by a first signal from the telecommunication network, the network node being adapted to:
selectively transmit a second signal to one or more terminal devices in the telecommunication network to provide an additional RA resource, the second signal indicating information required for a RA request on the additional RA resource by the one or more terminal devices.

19. The network node as claimed in claim 18, wherein the network node is adapted to selectively transmit the second signal when additional RA resource is required.

20. The network node as claimed in claim 18, wherein the network node is adapted to selectively transmit the second signal in response to information received from another network node.

21. The network node as claimed in claim 18, wherein the step of selectively transmitting the second signal comprises transmitting the second signal when a signal metric for the periodic RA resource meets a predetermined criteria.

22. The network node as claimed in claim 18, wherein the network node is further adapted to transmit an indication to the one or more terminal devices that the second signal is to be transmitted.

23-28. (canceled)

29. A method of operating a terminal device in a telecommunication network, the method comprising:
receiving a first signal from a network node in the telecommunication network that indicates information required for a random access, RA, request by the terminal device on a periodic RA resource; and
receiving a second signal from a network node that indicates information required for a RA request by the terminal device on an additional RA resource to the periodic RA request.

30. The method as claimed in claim 29, wherein the information required for a RA request on the periodic RA resource indicated in the first signal comprises information on timing and/or frequency alignment of the RA request and/or transmission power to be used by the terminal device.

31. The method as claimed in claim 29, wherein the information required for a RA request on the additional RA resource indicated in the second signal comprises information on timing and/or frequency alignment of the RA request and/or transmission power to be used by the terminal device.

32. The method as claimed in claim 29, wherein the first signal further indicates timing information for the transmission of the second signal.

33. The method as claimed in claim 32, wherein the timing information indicates one or more time offsets from the transmission of the first signal that the second signal is to be transmitted.

34-54. (canceled)

55. A terminal device for use in a telecommunication network, the terminal device being adapted to:
receive a first signal from a network node in the telecommunication network that indicates information required for a random access, RA, request on a periodic RA resource by the terminal device; and
receive a second signal from a network node that indicates information required for a RA request on an additional RA resource to the periodic RA resource by the terminal device.

56. The terminal device as claimed in claim 55, wherein the terminal device is further adapted to receive an indication from a network node that the second signal is to be transmitted.

57. The terminal device as claimed in claim 55, wherein the terminal device is further adapted to receive a mapping between the second signal and one or more terminal devices that are permitted to use the additional RA resource.

58. The terminal device as claimed in claim 57, wherein the terminal device is further adapted to determine whether to transmit a RA request on the periodic RA resource or the additional RA resource based on the received mapping.

59. The terminal device as claimed in claim 55, wherein the terminal device is further adapted to receive a mapping between the first signal and one or more instances of the second signal.

60-72. (canceled)
